(19) United States
(12) Patent Application Publication
(10) Pub. No.: US 2014/0294241 A1
(43) Pub. Date: Oct. 2, 2014

(54) VEHICLE HAVING GESTURE DETECTION SYSTEM AND METHOD

(71) Applicant: HYUNDAI MOTOR COMPANY, Seoul (KR)

(72) Inventor: Sung Un Kim, Yongin (KR)

(73) Assignee: HYUNDAI MOTOR COMPANY, Seoul (KR)

(21) Appl. No.: 14/098,848

(22) Filed: Dec. 6, 2013

(30) Foreign Application Priority Data
Mar. 29, 2013 (KR) 10-2013-0034857

(51) Int. Cl. B60W 50/08; G06K 9/00

(52) U.S. Cl. CPC B60W 50/08; G06K 9/00335
USPC 382/104

(57) ABSTRACT

A vehicle having a gesture detection system and a gesture detection method of a vehicle are provided. The system includes an ignition key that has a first light source disposed on a first side of the ignition key and an imaging device that is disposed at one side of a vehicle body to detect the image of the first light source. An image processor is configured to processes the image detected by the imaging device to detect a movement trace of the first light source and a controller configured to execute a function based on the shape or characteristics of the movement trace detected by the image processor. Accordingly, the function of a vehicle is controlled by operating an ignition key through a first light source or source second light source disposed on the ignition key.

### CROSS-REFERENCE TO RELATED APPLICATION

This application claims priority to and the benefit of Korean Patent Application No. 10-2013-0034857 filed in the Korean Intellectual Property Office on Mar. 29, 2013, the entire contents of which are incorporated herein by reference.

### BACKGROUND

(a) Field of the Invention

The present invention relates to a vehicle having a gesture detection system that controls a function of a vehicle using a gesture of a driver to improve the user convenience.

(b) Description of the Related Art

A system that uses an image to recognize a gesture of a user, or an inertia sensor or an acceleration sensor is used to a gesture of a user has been developed. However, when an image is used, cost for processing image data increases, and when an inertia sensor or an acceleration sensor is built into a system, battery consumption and the cost increase.

The above information disclosed in this section is only for enhancement of understanding of the background of the invention and therefore it may contain information that does not form the prior art that is already known in this country to a person of ordinary skill in the art.

### SUMMARY

The present invention provides a vehicle having a gesture detection system that has a simplified structure and controls a function of a vehicle to improve user convenience.

A vehicle having a gesture detection system according to an exemplary embodiment of the present invention may include an ignition key that may be portable and that may have a first light source at one side thereof, an imaging device (e.g., a camera, a video camera, etc.) disposed at one side of a vehicle body to detect the image of the first light source, an image processor configured to process the image detected by the imaging device to detect a movement trace of the first light source, and a controller configured to execute a function based on the shape or characteristics of the movement trace detected by the image processor.

A second light source may be disposed near the first light source on the ignition key (e.g., at another side of the ignition key) and the controller may be configured to execute a function based on the shape or characteristics of the movement trace of the first light source and the second light source. The first and second light sources may be light emitting diodes (LED).

The vehicle having a gesture detection system may further include a photo sensor configured to recognize a frequency transmitted from the first light source and configured to operate the imaging device based on the recognized information. The controller may be configured to execute the function of vehicle parts such as a window, the air-conditioner, a parking brake, a vehicle light, or a door. The imaging device may have a function that detects a lane of a road or a surrounding object.

As described above, a vehicle having a gesture detection system according to an exemplary embodiment of the present invention may execute the function of a vehicle by operating an ignition key of a driver using one light source or a second light source disposed on an ignition key.

### BRIEF DESCRIPTION OF THE DRAWINGS

FIG. 1 is an exemplary schematic diagram of a vehicle having a gesture detection system according to an exemplary embodiment of the present invention;

FIG. 2 is an exemplary flowchart showing a control method of a vehicle having a gesture detection system according to an exemplary embodiment of the present invention; and

FIG. 3 is an exemplary flowchart showing a control method of a vehicle having a gesture detection system according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An exemplary embodiment of the present invention will hereinafter be described in detail with reference to the accompanying drawings.

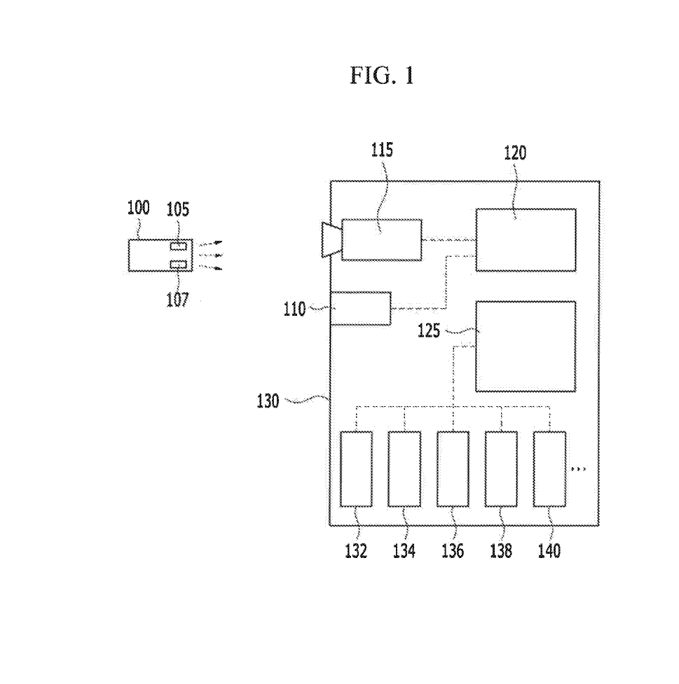

FIG. 1 is an exemplary schematic diagram of a vehicle having a gesture detection system according to an exemplary embodiment of the present invention. Referring to FIG. 1, a vehicle having a gesture detection system 130 may include an imaging device 115 (e.g., a camera, a video camera, etc.), a photo sensor 110, an image processor 120, a function controller 125, a window 132, an air-conditioner 134, a brake 136, a vehicle light 138, a door 140, and an ignition key 100.

Further, a first light source 105 may be disposed on a first side of the ignition key 100, and a second light source 107 may be selectively disposed spaced a distance from the first light source 105 (e.g., disposed on a second side of the ignition key 100). The photo sensor 110 may be selectively applied to an exemplary embodiment of the present invention. In particular, the photo sensor 110 may be configured to detect a predetermined light signal (e.g., infrared ray or visible ray of predetermined frequency) generated from the first light source 105 or the second light source 107 disposed on the ignition key 100 and the imaging device 115 may be operated based on the signal detected by the photo sensor 110. In other words, the photo sensor may be configured to recognize the characteristics of the first and second light source from the various signals transferred from the exterior of the vehicle.

In an exemplary embodiment of the present invention, the first light source 105 or the second light source 107 may be a LED. Further, the imaging device 115 may be disposed on one side of a vehicle body and may be configured to detect a road lane or a front side object. The imaging device 115 may be configured to detect the image including the first light source 105 or the second light source 107, and the detected image may be processed by the image processor 120 of the function controller 125. The image processor 120 may be configured to recognize the image from the imaging device 115.

Additionally, the function controller 125 may be configured to perform a predetermined program or algorithm to execute functions that a vehicle may perform based on the movement trace of the first light source 105 or the movement trace of the second light source 107 of the ignition key 100 recognized by the image processor 120.

In an exemplary embodiment of the present invention, the function controller 125 may be configured to operate a window 132, an air-conditioner 134, a brake 136, a vehicle light 138, and a door 140. Further, the image processor 120 may be configured to recognize the gesture of a user through a shape or a moving trace of the first light source 105 and the second light source 107, recognize the distance between the vehicle 130 and the ignition key 100 based on the distance between the first light source 105 and the second light source 107 detected by the imaging device, and recognize the three-dimensional movement of the ignition key.

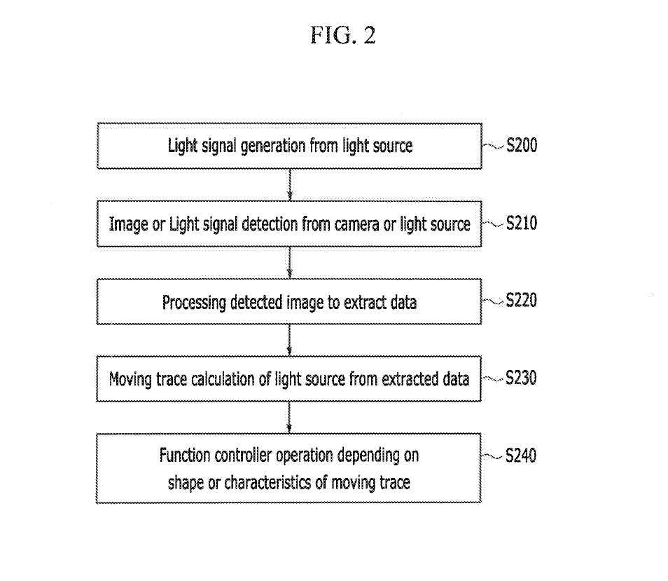

FIG. 2 is an exemplary flowchart showing a control method of a vehicle having a gesture detection system according to an exemplary embodiment of the present invention. Referring to FIG. 2, in S200, a light signal may be generated from the first light source 105 or the second light, source 107 of the ignition key 100 that may be portable. The light signal may be generated by pressing a push button disposed on the ignition key 100.

The imaging device 115 or the photo sensor 110 may be configured to recognize the first and second light source in a S210, and the imaging device 115 may be configured to detect the image including the first light source or the second light source. The image detected by the imaging 115 or the photo sensor 110 may be processed by the image processor 120 and data from the image may be extracted in a S220.

Additionally, the moving trace of the first light source 105 or second light source 107 may be calculated by the image processor 120 from the extracted data in a S230. The function controller 125 may be configured to operate a window 132, an air-conditioner 134, a brake 136, a vehicle light 138, and a door 140 in a predetermined condition based on the shape or the characteristics of the moving rote of the first light source 105 or the second light source 107 in a S240.

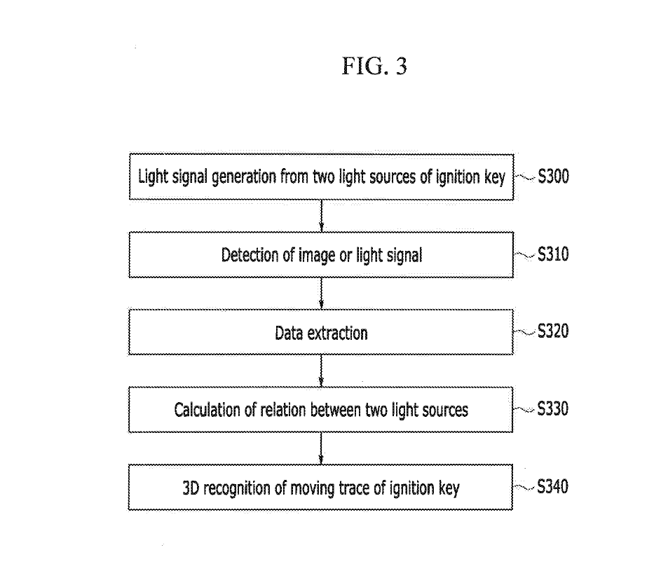

FIG. 3 is an exemplary flowchart showing a control method of a vehicle having a gesture detection system according to another exemplary embodiment of the present invention. Referring to FIG. 3, the ignition key 100 may be operated to cause the first light source 105 or the second light source 107 to generate signals having a predetermined range of frequency in S300. The imaging device 115 or the photo sensor 110 may be configured to detect the characteristics such as the frequency of the first light source 105 or the second light source 107 and may not detect the characteristics of second light source from the exterior in S310.

The image processor 120 may be configured to extract data including a moving shape or moving characteristics of the first light source 105 or the second light source 107 from the detected image in S320 and calculate a relation between the first light source 105 and the second light source 107 in S330. In addition, the three-dimensional moving trace of the ignition key may be recognized based on the relation between the first light source 105 and the second light source 107 in S340. A distance between the ignition key and the vehicle may be recognized through a relation between the first and second light source.

The ignition key 100 may be operated at a predetermined distance from the vehicle causing the first light source 105 or the second light source 107 of the ignition key to be operated to close the window 132 and turn on or off a heater or a cooler of an air-conditioner in an exemplary embodiment of the present invention. Further, a parking brake may be operated via the operation of the brake 136, the vehicle light 138 may be turned off or on, and the door 140 may be locked, unlocked, opened, or closed when the ignition key 100 is operated.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

Description of symbols

| | |
|---|---|
| 100: ignition key | 105: first light source |
| 107: second light source | 110: photo sensor |

| | |
|---|---|
| 115: imaging device | 120: image processor |

| | |
|---|---|
| 125: controller | 130: vehicle |

| | |
|---|---|
| 132: window | 134: air-conditioner |
| 136: brake | 138: vehicle light |

140: door

What is claimed is:

1. A vehicle having a gesture detection system, comprising:
an ignition key having a first light source on a first side of the ignition key;
an imaging device disposed at one side of a vehicle body to detect the image of the first light source;
an image processor configured to process the image detected by the imaging device to detect a movement trace of the first light source; and
a controller configured to execute a vehicle function based on the shape or characteristics of the movement trace detected by the image processor.

2. The vehicle having a gesture detection system of claim 1, further comprising:
a second light source disposed on a second side of the ignition key, wherein the controller is configured to execute a vehicle function based on the shape or characteristics of the movement trace of the first and second light sources.

3. The vehicle having a gesture detection system of claim 2, wherein at least one of the first and second light sources is a light emitting diode (LED).

4. The vehicle having a gesture detection system of claim 1, further comprising:
a photo sensor configured to recognize a frequency transmitted from the first light source and operate the imaging device based on the recognized frequency.

5. The vehicle having a gesture detection system of claim 1, wherein the controller is further configured to execute the vehicle function selected from a group consisting of: a window, an air-conditioner, a parking brake, a vehicle light, and a door.

6. The vehicle having a gesture detection system of claim 1, wherein the imaging device is configured to detect a lane of a road or a surrounding object.

7. The vehicle having a gesture detection system of claim 1, wherein the ignition key is portable.

8. A gesture detection method of vehicle, comprising:
detecting, by a controller, an image based on a light signal generated from a first light source disposed on a first side of an ignition key;
processing, by the controller, the detected image to extract image data;
calculating, by the controller, trace movement of the first light source from the extracted image data; and
operating, by the controller, a plurality of vehicle functions based on the shape or characteristics of the trace movement of the first light source,

9. The method of claim 8, further comprising:
operating, by the controller, the plurality of vehicle functions based on the shape or characteristics of the movement trace of the first light source and a second light source disposed on a second disposed of the ignition key.

10. The method of claim 9, wherein at least one of the first and second light sources is a light emitting diode (LED).

11. The method of claim 8, further comprising:
recognizing, by the controller, a frequency transmitted from the first light source based on information from a photo sensor; and
operating, by the controller, an imaging device based on the recognized frequency.

12. The method of claim 8, wherein the plurality of vehicle functions are selected from a group consisting of: a window, an air-conditioner, a parking brake, a vehicle light, and a door.

13. A non-transitory computer readable medium containing program instructions executed by a controller, the computer readable medium comprising:
program instructions that control an imaging device to detect an image based on a light signal generated from a first light source disposed on a first side of an ignition key;
program instructions that process the detected image to extract image data;
program instructions that calculate trace movement of the first light source from the extracted image data; and
program instructions that operate a plurality of vehicle functions based on the shape or characteristics of the trace movement of the first light source.

14. The non-transitory computer readable medium of claim 13, further comprising:
program instructions that operate the plurality of vehicle functions based on the shape or characteristics of the movement trace of the first light source and a second light source disposed on a second disposed of the ignition key.

15. The non-transitory computer readable medium of claim 14, wherein at least one of the first and second light sources is a light emitting diode (LED).

16. The non-transitory computer readable medium of claim 13, further comprising:
program instructions that recognize a frequency transmitted from the first light source based on information from a photo sensor; and
program instructions that operate the imaging device based on the recognized frequency.

17. The non-transitory computer readable medium of claim 13, wherein the plurality of vehicle functions are selected from a group consisting of: a window, an air-conditioner, a parking brake, a vehicle light, and a door.
